(19) United States
(12) Patent Application Publication
(10) Pub. No.: US 2025/0069260 A1
(43) Pub. Date: Feb. 27, 2025

(54) CONTROL UNIT AND METHOD FOR DETERMINING THE POSITION OF A BUMPER OF A CLEANING APPARATUS

(71) Applicant: BSH Hausgeräte GmbH, München (DE)

(72) Inventors: Manuel WEIDL, Salz (DE); Frank SCHNITZER, Bad Neustadt (DE)

(21) Appl. No.: 18/813,370

(22) Filed: Aug. 23, 2024

(30) Foreign Application Priority Data
Aug. 24, 2023 (DE) 10 2023 208 117.2

(51) Int. Cl. G06T 7/73; A47L 9/28; A47L 9/30

(52) U.S. Cl. CPC G06T 7/74; A47L 9/2805; A47L 9/2842; A47L 9/2852; A47L 9/30; A47L 2201/04; A47L 2201/06; G06T 2207/20132

(57) ABSTRACT

A control unit determines position information of the position of a bumper which is movably mounted on a cleaning apparatus. The control unit captures image data, by way of a camera of the cleaning apparatus, relative to one or more reference points which are fixedly connected to the bumper, and to determine the position information concerning the position of the bumper on a basis of the image data.

### CROSS-REFERENCE TO RELATED APPLICATION

This application claims the priority, under 35 U.S.C. § 119, of German Patent Application DE 10 2023 208 117.2, filed Aug. 24, 2023; the prior application is herewith incorporated by reference in its entirety.

### FIELD AND BACKGROUND OF THE INVENTION

The invention relates to a cleaning apparatus, in particular for a cleaning robot. The invention relates, in particular, to a control unit and a method for determining the position of a bumper of a cleaning apparatus.

A cleaning apparatus, such as a suction apparatus, typically has a suction nozzle with a suction opening, via which contaminants or dirt, such as dust particles, are suctioned from a floor to be cleaned by way of an airflow. The airflow can be generated by a fan. The dirt is conveyed by the airflow from the suction opening into a dirt collection container of the suction apparatus.

The cleaning apparatus may be configured to move autonomously over the floor to be cleaned. To this end, the cleaning apparatus can have a chassis.

A cleaning apparatus, in particular a cleaning robot, can have a movable, in particular spring-mounted, bumper (or shock absorber) by which impacts of the cleaning apparatus against an obstacle can be identified and optionally damped. The cleaning apparatus can also have an impact sensor by which the deflection of the bumper can be detected. Exemplary impact sensors are mechanical tactile sensors and/or light barriers. The operation of the cleaning apparatus can be adapted as a function of the sensor data of the impact sensor. For example, the direction of movement of the cleaning apparatus can be adapted in response to an identified deflection of the bumper in order to avoid an obstacle.

### SUMMARY OF THE INVENTION

The installation of a dedicated impact sensor is associated with higher costs and with a greater constructional space requirement. It is accordingly a technical object the invention to provide for a detection of the deflection of the bumper of a cleaning apparatus in a manner which is particularly efficient, reliable and accurate.

With the above and other objects in view there is provided, in accordance with the invention, a control unit for determining position information regarding a position of a bumper that is movably mounted to a cleaning apparatus. The control unit comprises:
an input for receiving image data, captured by way of a camera of the cleaning apparatus, relative to one or more reference points that are fixedly connected to the bumper; and
wherein the control unit is configured to process the image data to determine the position information regarding the position of the bumper based on the image data.

With a view to one aspect of the invention, there is described a control unit for determining position information regarding the position of a bumper which is movably mounted on a cleaning apparatus. The determined position information thus relates to the position of the bumper. In particular, the position information can specify the (spatial) position of the bumper (optionally relative to the cleaning apparatus). The (spatial) position can comprise the position and/or the orientation as a component. Optionally, the position of the bumper can correspond to the (spatial) pose of the bumper.

The bumper can be optionally configured to comprise a specific number of different spatial positions (in particular poses). The position information can specify the position from the number of different (spatial) positions which the bumper currently comprises.

As an alternative to the term “position information relative to the position of the bumper,” the term “position information which relates to the position of the bumper” or the term “position information which specifies the position of the bumper” can be used in the description and/or in the claims.

The cleaning apparatus may be, in particular, a cleaning robot which is configured to move autonomously in order to carry out a cleaning process. The cleaning apparatus typically comprises a cleaning unit for cleaning a surface. Moreover, the cleaning apparatus can comprise a drive unit which is configured to move the cleaning apparatus (for example to move it over the surface to be cleaned).

The control unit is designed to capture image data, by way of a camera of the cleaning apparatus, relative to one or more reference points which are (typically fixedly) connected to the bumper. The camera can also be used to capture image data relative to the environment of the cleaning apparatus (for example relative to the environment which is arranged in the direction of movement in front of the cleaning apparatus). The image data can be used, for example, to identify obstacles in the environment of the cleaning apparatus and/or in order to permit an automatic navigation of the cleaning apparatus.

The camera can be arranged in the housing of the cleaning apparatus such that the camera is concealed by the bumper (and the camera is thus shielded by the bumper). The bumper can have an opening within the capture region of the camera so that the camera is able to capture image data relative to the environment of the cleaning apparatus through the opening of the bumper.

The one or more reference points are arranged in the capture region of the camera. The one or more reference points can be arranged (at least partially), for example, on the non-transparent edge of the opening of the bumper. In particular, the one or more reference points can comprise the non-transparent edge of the opening of the bumper or correspond to the edge of the opening.

The opening of the bumper can be covered by a (transparent) window pane (for example in order to protect the camera from environmental influences). The one or more reference points can comprise one or more markings on the window.

The individual reference points can have in each case a specific two-dimensional extent. Moreover, the individual reference points can have in each case a specific shape and/or a specific pattern. The individual reference points can have in each case a two-dimensional extent which corresponds, for example, to 0.5% or less, or 0.1% or less, of the entire surface area of an image captured by the camera. As an alternative or in addition, the individual reference points can have in each case a two-dimensional extent so that the individual reference points are represented in each case by a pixel, preferably in each case by at least Q pixels, in an image captured by the camera. By way of example, Q≥2 or Q≥10, or Q lies between 10 and 50 or Q lies between 5 and 100.

Thus one or more reference points can be captured by the camera, wherein the one or more reference points are configured such that the reference points move together with the bumper (so that a corresponding movement of the bumper relative to the housing of the cleaning apparatus can be inferred from a movement of the one or more reference points). Preferably, a plurality of reference points which are arranged at different points of the bumper are taken into account in order to increase the accuracy of the position information determined on the basis thereof with reference to the position of the bumper.

The control unit is designed to determine the position information relative to the position of the bumper on the basis of the image data, in particular on the basis of the one or more reference points represented in the image data. The position information can specify the position and/or the orientation of the bumper relative to the housing of the cleaning apparatus. In particular, the position information can specify the pose of the bumper (for some of the 6 degrees of freedom and/or for all of the 6 degrees of freedom) relative to the housing of the cleaning apparatus.

As position information, for example, it is possible to determine whether the bumper has been pushed in or not pushed in, starting from the resting position of the bumper. This information can be provided, for example, in binary form (for example “pushed in” or “not pushed in”). Moreover, as position information it is optionally possible to determine in which direction the bumper has been pushed in, for example head-on in the center, on the right-hand side or on the left-hand side of the bumper.

For example, a specific number of states of the bumper can be defined. The individual states can define in each case a specific (spatial) position of the bumper. The number of states can be, for example, the states: “resting position,” “pushed in centrally,” “pushed in on the right-hand side” and/or “pushed in on the left-hand side.” As position information, it is possible to determine the state in which the bumper is currently located from the number of predefined states.

As an alternative or in addition, the position information can specify the position and/or orientation of the bumper in the room (relative to the housing of the cleaning apparatus) with a relatively high value resolution (for example in each case 2 or more, or 3 or more, or 4 or more different values for each degree of freedom).

Thus a camera can be used in order to determine the position of the bumper of the cleaning apparatus in an efficient and accurate manner. In particular, it can be determined whether the bumper has been deflected or not deflected, starting from the resting position of the bumper. It can also be determined in which direction the bumper has been deflected (for example in the longitudinal direction and/or in the transverse direction of the cleaning apparatus). The use of the image data of the camera makes it possible to dispense with the installation of a dedicated impact sensor. Moreover, the position information can be determined with greater accuracy.

The control unit can be designed to operate the cleaning apparatus, in particular the cleaning unit and/or the drive unit of the cleaning apparatus, as a function of the determined position information. Due to the fact that the position information can be determined with a particularly high degree of accuracy, (so that already relatively small deflections of the bumper from the resting position can be identified) a particularly reliable and careful operation of the cleaning apparatus is made possible.

The image data typically comprises at least one image in which the one or more reference points are represented. Generally the image data comprises a chronological sequence of images in which the one or more reference points are represented in each case. The individual images can be analyzed in each case in the described manner in order to determine the position information in a particularly accurate manner and/or as a function of the time.

The control unit can be designed to determine one or more properties of the one or more reference points represented in the image (by using an image analysis algorithm). Exemplary properties of the individual reference points represented in the image comprise:
the position of the reference point within the image;
the size of the reference point represented; and/or
the shape and/or the pattern of the reference point represented.

The position information can be determined in a particularly accurate manner on the basis of the one or more determined properties of the one or more reference points represented.

The control unit can be designed to determine the position information relative to the position of the bumper by using a predefined assignment function. The assignment function can be configured to assign different positions of the bumper to different combinations of one or more properties of the one or more reference points. The assignment function can comprise, for example, a look-up table and/or one or more analytical functions. In each case the position of the bumper can be specified for 2 or more, or for 4 or more, or for 10 or more, or 100 or more, or 1,000 or more, or 10,000 or more different combinations. By using an assignment function determined in advance, the position information can be determined in a particularly accurate manner during the operation of the cleaning apparatus.

The control unit can be designed to capture reference image data, by way of the camera, relative to the one or more reference points when the bumper is in a reference position, in particular in the resting position. Moreover, the control unit can be designed to calibrate, on the basis of the reference image data, the assignment function (which is used to determine the position information relative to the position of the bumper on the basis of the image data). The calibration of the assignment function can be carried out repeatedly, in particular after a reset and/or restart of the cleaning apparatus and/or before the start of a cleaning process, namely before the start of each individual cleaning process. The position information can be continuously determined relative to the position of the bumper with a particularly high degree of accuracy by the (optionally repeated) calibration of the assignment function.

The control unit may be configured to determine that a “lighting situation” currently exists (for example when, namely due to relatively poor lighting conditions, the one or more reference points cannot be identified in the captured image data). In response to the determination it can be brought about that the one or more reference points are illuminated by one or more lighting elements (for example LEDs) of the cleaning apparatus. Thus even in the case of darkness the position information can be determined in an accurate manner.

The image data captured by the camera can comprise an overview image, or overall image, in which the one or more reference points and the environment of the cleaning apparatus are represented. The control unit can be designed to crop the overview image in order to provide a partial image in which the environment of the cleaning apparatus is represented, but not the one or more reference points. To this end, the one or more reference points are preferably arranged on the edge or in the margins of the overview image. Thus it can be brought about that the partial image (rather than the entire image) is provided to a user of the cleaning apparatus. Thus a particularly simple operation of the cleaning apparatus can be made possible (even when the image data is used for determining the position information).

According to a further aspect, a cleaning apparatus, in particular a cleaning robot, is described. The cleaning apparatus comprises a cleaning unit which is designed to clean a surface, for example a surface on which the cleaning apparatus is arranged and/or on which the cleaning apparatus moves. The cleaning apparatus also comprises a bumper which is movably mounted on the housing of the cleaning apparatus, and a camera which is designed to capture image data, in particular image data relative to the environment of the cleaning apparatus. Moreover, the cleaning apparatus comprises a control unit which is designed to determine position information relative to the position of the bumper (and which is configured as described in this document).

According to a further aspect, a method is described for determining position information relative to the (spatial) position (in particular the pose) of a bumper which is movably mounted on a cleaning apparatus. The method comprises the capture of image data, by way of a camera of the cleaning apparatus, relative to one or more reference points which are connected to the bumper. Moreover, the method comprises the determination of the position information relative to the position of the bumper on the basis of the image data.

It should be noted that any aspects of the control unit described in this document and/or the cleaning apparatus described in this document and/or the method described in this document may be combined in a variety of different ways. In particular, the features of the appended claims can be combined with one another in many different ways.

Although the invention is illustrated and described herein as being embodied in a control unit and method for determining the position of a bumper of a cleaning apparatus, such as a cleaning robot, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is an upper perspective view of an exemplary cleaning robot, being an example of a cleaning apparatus and/or suction apparatus according to the invention;

FIG. 1B is a lower perspective view thereof;

FIG. 1C is a diagrammatic view of the exemplary components of a cleaning apparatus;

FIG. 2 shows an exemplary capture region of a camera;

FIG. 3A shows an exemplary bumper window with a plurality of reference points;

FIG. 3B shows exemplary reference points; and

FIG. 4 shows a flow diagram of an exemplary method for determining the position of a bumper.

### DETAILED DESCRIPTION OF THE INVENTION

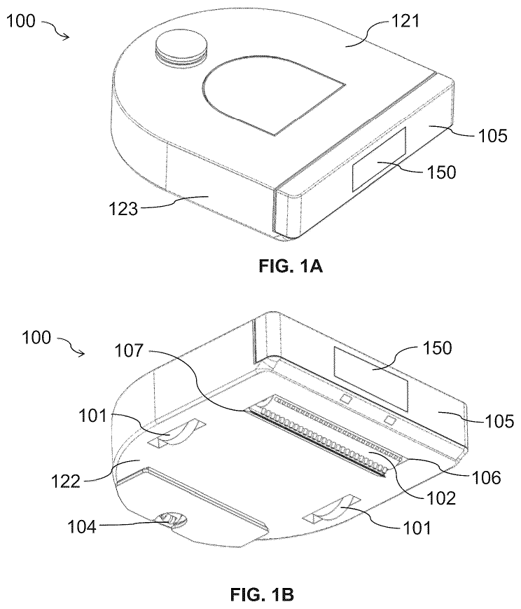

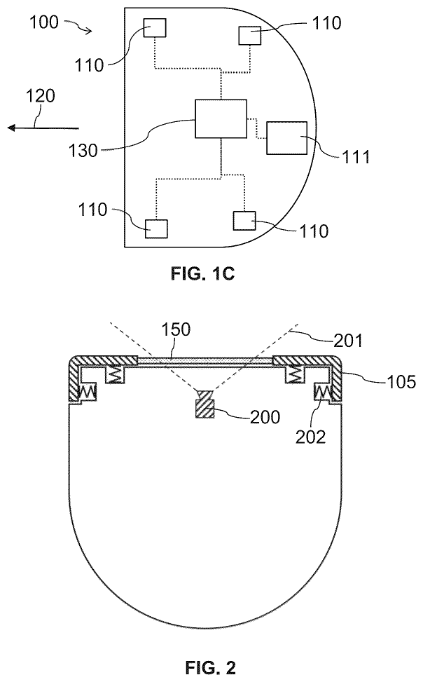

As already set forth in the introduction, the present document refers to the efficient and reliable determination of the position of the bumper of a cleaning apparatus. In this context FIG. 1A shows the upper face 121 and FIG. 1B shows the lower face 122 of a cleaning robot 100 as an example of a cleaning apparatus. In the exemplary case, the cleaning apparatus is a suction apparatus. The aspects specifically described for a cleaning robot generally apply to a cleaning apparatus.

In the cleaning mode of the cleaning robot 100 the lower face 122 faces the floor to be cleaned or the surface to be cleaned of a cleaning region, namely a room. The lower face 122 of the cleaning robot 100 typically has one or more drive units 101 (with one or more drive wheels) by which the cleaning robot 100 can move autonomously in order to clean different regions of a floor. Moreover, the cleaning robot 100 can have one or more guide elements and/or support elements 104 (for example non-driven wheels) which permit a stable movement of the cleaning robot 100 over the floor to be cleaned. Moreover, a cleaning robot 100 typically comprises one or more cleaning units 106 (in particular suction nozzles) which are designed to clean the floor below the cleaning robot 100.

A cleaning unit 106 (in particular a suction nozzle) can have a brush roller 102 which is configured to rotate about an axis of rotation, wherein the axis of rotation is typically arranged parallel to the lower face 122 of the cleaning robot 100. The brush roller 102 can be used to dislodge mechanically from the floor any dust and/or contaminants on the floor to be cleaned, so that the dust and/or the contaminants can be suctioned with greater reliability into the suction opening 107 of the cleaning unit 106.

A user interface which permits a user of the cleaning robot 100 to activate control inputs can be arranged on the upper face 121 of the cleaning robot 100. Moreover the cleaning robot 100 can comprise a bumper 105 on a side wall 123 (for example on a side wall 123 in the front region of the cleaning robot 100), wherein an impact sensor can be arranged on the bumper 105, said impact sensor being designed to capture sensor data which indicates whether the cleaning robot 100 (for example in the direction of movement 120 and/or when rotating and/or when cornering) is pushed against an obstacle or not. The triggering of the impact sensor (due to the deflection of the bumper 105) can be brought about by an obstacle, such that the cleaning robot 100 rotates, for example, about its vertical or height axis standing vertically on the floor and thereby changes the direction of movement 120 in order to avoid the obstacle.

Moreover, a cleaning robot 100 typically has one or more environment sensors 110 (see FIG. 1C) which are designed to capture environment data or sensor data relative to the environment of the cleaning robot 100. The one or more environment sensors 110 can comprise: one or more image cameras, one or more ultrasound sensors, one or more tactile sensors and/or optical distance sensors, one or more acoustic sensors, one or more temperature sensors, one or more lidar sensors and/or radar sensors, etc. A control unit 130 of the cleaning robot 100 can be designed to determine digital map information on the basis of the environment data relative to the cleaning region to be cleaned, and optionally to store this information on a memory unit 111 of the cleaning robot 100. The cleaning robot 100 can use the digital map information in order to orientate itself within the cleaning region (for example inside a room) and/or to fix a travel route for cleaning the cleaning region.

The cleaning robot 100 can comprise, in particular, a camera as an environment sensor 110 which is designed to capture image data relative to the environment of the cleaning robot 100. The camera can be installed, for example, behind a protective window pane 150, window for short, wherein the protective window 150 can be integrated in the bumper 105. FIG. 2 shows an exemplary camera 200 with a specific capture region (in particular field of view) 201, wherein the protective window 150 is arranged (at least partially or entirely) within the capture region 201 of the camera 200. Moreover, FIG. 2 shows a bumper 105 which is movably mounted on the cleaning robot 100, for example via one or more spring elements 202.

A camera 200 which captures the environment of the cleaning robot 100 through a window 150 which is connected to the bumper 105 can be used in order to determine position information in an efficient and accurate manner relative to the position of the bumper 105. This also makes it possible to dispense with the installation of an additional impact sensor.

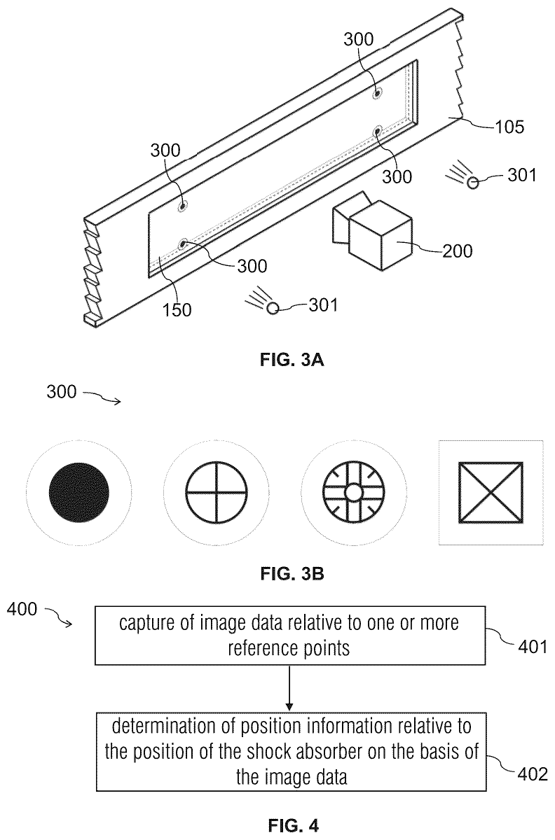

As shown by way of example in FIG. 3A, a plurality of reference points 300 can be arranged in the capture region 201 of the camera 200. A reference point 300 can be arranged, for example, on the window 150, for example as a marking on the window. As an alternative or in addition, a reference point can be arranged on the frame of the window 150 or formed by the frame of the window 150. In the example shown in FIG. 3A, four reference points 300 are arranged in each case as markings at different reference points on the window 150. The individual reference points 300 are connected fixedly to the bumper 105 so that a change in the position of the bumper 105 leads to a corresponding change in the position of the reference points 300.

The individual reference points 300 can be configured such that even in the case of darkness the reference points 300 can be captured by the camera 200. To this end, the cleaning robot 100 can comprise one or more lighting elements 301 which are configured to illuminate the one or more reference points 300.

FIG. 3B shows exemplary embodiments of reference points 300. The individual reference points 300 are preferably configured such that the individual reference points 300 can be identified reliably within the images captured by the camera 200.

The control unit 130 of the cleaning robot 100 can be designed to capture one or more images, by way of the camera 200, relative to the reference points 300 connected to the bumper 105. The one or more images can be analyzed by way of an image analysis algorithm, in order to determine one or more properties (in particular the position and/or the size) of the reference points 300 within the one or more captured images. In turn, the position of the bumper 105 can be inferred from the one or more properties of the reference points 300.

Thus the front camera 200 of a cleaning robot 100 (generally of a cleaning apparatus) can be used to identify and/or evaluate the movement of the bumper 105 (i.e. the bumper) triggered by a collision. The camera 200 can track markings 300 (i.e. reference points) on a window 150 in the bumper 105, the position of the bumper 105 being able to be derived from the positions thereof. As an alternative or in addition, the pose of the window frame itself can be tracked by the camera 200, instead of markings 300 on the window. The window frame thus represents a number of reference points 300.

The cleaning robot 100 can comprise a dry cleaning unit 106 (with a suction fan, filter, dust container, suction opening 107 and/or brush roller 102) and/or a wet cleaning unit (with a water tank, pump and/or mopping pad). At least one camera 200 which can be used, for example, for video streaming, environment mapping and/or object recognition is accommodated in the front region of the cleaning robot 100. When video streaming, the user can track live exactly what the cleaning robot 100 sees in front of itself. The mapping is carried out in order to survey the environment of the cleaning robot 100 and, for example, to determine the position and size of the rooms to be cleaned. The object recognition serves for the capture, evaluation and/or classification of objects and obstacles in front of the cleaning robot 100 in order to be able to avoid, for example, shoes, cables or chair legs.

The front of the cleaning robot 100 is formed by a bumper 105 which is displaceably fastened to the housing of the cleaning robot 100. A transparent window 150 is typically integrated in the bumper 105 in the viewing cone 201 of the camera 200. When using markings 300 on the window 150, with a movement of the bumper 105 relative to the housing of the cleaning robot 100, i.e. with a relative movement of the bumper 105 in relation to the camera 200, the viewing cone 201 of the camera 200 typically remains within the surface area of the transparent window 150. If the window frame is used for capturing the movement of the bumper 105, however, this is preferably arranged entirely in the viewing cone 210 of the camera 200, at least in the neutral position.

The bumper 105 can be held by four springs 202 (for example compression springs, leaf springs, or the like) in a starting position or resting position. When colliding with an obstacle, the bumper 105 is pushed counter to the spring forces against the housing of the cleaning robot 100. The bumper 105 can optionally move within three degrees of freedom:
If the cleaning robot 100 travels head-on toward an obstacle which is located centrally in front thereof or which is relatively wide, the bumper 105 is pushed to the rear against the cleaning robot 100. In this case, the bumper 105 moves primarily counter to the longitudinal direction 120 of the cleaning robot 100.
If the cleaning robot 100 rotates immediately, an obstacle can push the bumper 105 laterally against the cleaning robot 100. In this case, the bumper 105 moves primarily in a transverse direction to the cleaning robot 100 (transversely to the longitudinal direction 120).
If the cleaning robot 100 moves toward a laterally offset obstacle, the bumper 105 is pushed on only one side to the rear. In this case, the bumper 105 rotates slightly about the height axis of the cleaning robot 100 (which is arranged vertically relative to the floor to be cleaned).

In the case of an embodiment by way of markings 300 on the window 150, the transparent window 150 in the bumper 105 is provided with at least one marking 300. The one or more markings 300 can be adhesively bonded as stickers, applied as paint or engraved by means of lasers or an engraving machine. The one or more markings 300 are within the field of view 201 of the camera 200 so that the markings 300 can be read from the image data of the camera 200.

Objects in the room which are located behind a marking 300 are (partially) concealed by the marking 300. The one or more markings 300 are thus preferably relatively small and preferably positioned in the edge region of the image captured by the camera 200. For video streaming or taking photos using the camera 200 of the cleaning robot 100, the image edges of the respectively captured image can be cropped in order to remove the one or more markings 300 from the individual images and thus to avoid the user being distracted by the one or more markings 300.

The one or more markings 300 can be of any shape, size and/or design. Preferably, the one or more markings 300 do not need to be larger than for the resolution and/or image sharpness of the camera 200. The one or more markings 300 are preferably designed such that a corresponding image processing algorithm can detect and/or can track the one or more markings 300 reliably in the image data (captured by the camera 200), can establish the exact position thereof and/or—depending on the embodiment—can determine the size thereof or the deformation thereof in the image data. This can be an optical deformation of one or more markings 300, which results in the spatial position of the one or more markings 300 being changed relative to the camera 102.

The one or more markings 300 can be provided in each case with an edge which highlights the individual markings 300 in a particularly significant manner from an image background. This can be a plain, uniform single-color, for example white, edge.

The focal range of the camera 200 which is used generally starts at a certain distance in front of the bumper 105. This can lead to a lack of sharpness of the resolution of the one or more markings 300 captured by the camera 200. For an image analysis algorithm, it is typically possible to identify the one or more markings 300 even with a certain lack of sharpness, in particular when the structures on the one or more markings 300 are designed to be sufficiently pronounced and/or wide.

In the embodiment, a marking 300 is a single-color, for example black, circle. The position thereof can also be reliably determined in a relatively unsharp image by determining the centroid of all of the assigned pixels and this permits a further reduction in size of the marking 300. The edge around the marking 300 permits the differentiation of the relatively unsharp marking contour from the actual image contents (which typically represents the environment of the cleaning robot 100).

As an alternative or in addition to a plurality of individual (punctiform) and/or spatially local markings 300 in the edge region of the image, relatively large and/or linear structures can be used, namely lines parallel to the image edges or a frame in the form of a square which surrounds the entire image.

The determination of the movement of the bumper 105 takes place by the evaluation of the marking positions and optionally the position and/or size thereof. A lateral transverse movement of the bumper 105 leads to a horizontal movement of the markings 300 (i.e. the reference points), a longitudinal movement of the bumper 105 due to a head-on impact leads to a displacement of the markings 300 (i.e. the reference points) outwardly away from the image center. A rotation of the bumper 105 about its height axis (optionally only) on the side of the image on which the bumper 105 is pushed toward the cleaning robot 100, leads to one or more markings 300 (i.e. reference points) being pushed outwardly away from the image center. The evaluation of all movement types is thus possible when markings 300 are arranged in a plurality of different regions of the image (for example on the left-hand and right-hand edge).

The minimum number of markings 300 is one, in particular when such a marking is sufficiently large or long—namely a peripheral frame around the image. On a frame, for example, the corner points can be tracked or the paths of the connecting lines evaluated.

When using punctiform and/or locally defined markings 300, preferably at least two markings 300 are used (for example one on the left and one on the right in the image). Greater reliability of the evaluation or increased accuracy can be implemented by the use of more markings, namely 4 or more. The calculation of the bumper movement can be carried out by using one or more imaging equations (generally denoted as assignment functions). The displacements of the markings 300 in the image data provides conclusions about the state, in particular the position, of the bumper 105. By including a plurality of markings 300 in the image data (or a plurality of properties of one or more markings 300) the position information can be determined relative to up to 6 degrees of freedom. The degrees of freedom which can be used for the bumper 105 can be extracted from geometric data for the cleaning robot 100 or can be incorporated in the calculations as boundary conditions. As an alternative or in addition, the bumper movement or bumper position can be determined by means of a look-up table in which different configurations of bumper positions and marking positions have been previously input. The displacement of a marking 300 can be taken into account as the superimposition of different cases so that preferably a plurality of markings 300 are always taken into account at the same time, which can be implemented in the form of a matrix equation system (i.e. generally by an assignment function).

As an alternative or in addition to using markings 300 on the window 150, the size of the window can be selected such that the non-transparent region of the bumper 105 surrounding the window 150—i.e. the window frame—is located within the capture region 201 of the camera 200. The identification of the bumper movement takes place, for example, in a manner similar to the use of a rectangular marking 300 in the edge region of the window 150. In order to enable improved differentiation between the window frame and the window region, optionally any markings 300, for example a rectangular line, can be applied to the window frame. The use of the window frame has the advantage that this type of identification is not visible to the user and thus has less effect on the external appearance of the cleaning robot 100. On the other hand, when using the window frame the size of the usable image is potentially reduced.

A particularly high degree of accuracy when determining the current position and/or position of the bumper 105 can be implemented by a calibration. Such a calibration is carried out when the cleaning robot 100 is tested in the factory after the assembly thereof. In a calibration routine it is possible to push in the bumper 105 in a defined manner while the camera 200 measures the displacement of the bumper 105. In this manner, a look-up table can be determined and/or extreme positions of the bumper 105 can be determined so that it is possible to interpolate the values there between. A further form of calibration can be carried out with each start-up of the cleaning robot 100 (for example after a restart or before every start of a cleaning task). The cleaning robot 100 calibrates the starting position and/or resting position of the bumper 105 or the positions of the markings 300 associated with the starting position and/or resting position in the image of the camera 200. Thus it is possible to compensate for a change in the spring characteristics of the springs 202 over the service life, a distortion of the materials of the housing of the cleaning robot 100 and/or the bumper 105 and/or changes due to interim dismantling and assembly.

In the case of darkness, the camera 200 can potentially no longer capture its environment. However, in order to be able to evaluate the movement of the bumper 105, the markings 300 and/or the window frame (i.e. generally the reference points 300) can be illuminated from the inside. To this end, it is possible to use one or more LEDs 301 which are optionally already present on the printed circuit board of the camera 200 or the adjacent electronics. The markings 300 can be illuminated white, green, blue or red, for example, so that the markings 300 are highlighted sufficiently brightly relative to the background and thus can be identified.

FIG. 4 shows a flow diagram of a method 400 (optionally implemented by computer) for determining position information relative to the position of the bumper 105 (i.e. bumper) which is movably mounted on a cleaning apparatus 100, in particular on a cleaning robot. The method 400 can be performed by a control unit 130 of the cleaning apparatus 100.

The method 400 comprises the capture 401 of image data, by way of a camera 200 of the cleaning apparatus 100, relative to one or more reference points 300 which are connected to the bumper 105. Exemplary reference points 300 are markings on a viewing window 150 of the bumper 105 and/or the frame of a viewing opening of the bumper 105.

The method 400 further comprises the determination 402 of position information relative to the position of the bumper 105 on the basis of the image data (typically by using an assignment function determined and/or calibrated in advance).

Due to the measures described in this document, it is possible to dispense with the installation of dedicated bumper sensors (tactile sensors, light barriers, etc.). Thus the number of parts of the cleaning robot 100, the assembly effort and/or the costs can be reduced. Moreover, it is possible to avoid the distracting “clicking” noise which is generated when mechanical tactile sensors are activated.

The evaluation by image processing permits a fine-grained or stepless position determination. In particular, already relatively small movements of the bumper 105 can be captured by means of the camera 200. Thus the response time of the cleaning robot 100 can be reduced and/or a relatively earlier braking of the cleaning robot 100 can be implemented, whereby the impact force of the cleaning robot 100 and possible damage can be reduced.

The evaluation of a plurality of reference points 300 permits conclusions to be drawn about the collision site of the bumper 105. Thus it is possible to implement particularly accurate responses of the cleaning robot 100.

An installation of the bumper 105 with relatively high tolerances is also permitted, since the position of the reference points 300 in the camera image can be calibrated after assembly or with a restart of the cleaning robot 100.

It will be understood that the present invention is not limited to the exemplary embodiments shown. In particular, it should be noted that the description and the figures are designed to illustrate only the principle of the control unit described in this document and/or the cleaning apparatus described in this document and/or the method described in this document.

The following is a summary list of reference numerals and the corresponding structure used in the above description of the invention:
100 Cleaning apparatus (cleaning robot)
101 Drive unit
102 Brush roller
104 Guide element and/or support element
105 Bumper, shock absorber
106 Cleaning unit/suction nozzle
107 Suction opening
110 Environment sensor
111 Memory unit
120 Direction of movement/longitudinal direction
121 Upper face
122 Lower face
123 Side wall
130 Control unit
150 Window pane
200 Camera
201 Capture region (camera)
202 Spring unit
300 Reference point, marking
301 Lighting element
400 Method for determining the position of a bumper
401, 402 Method steps

1. A control unit for determining position information regarding a position of a bumper that is movably mounted to a cleaning apparatus, the control unit comprising:
an input for receiving image data, captured by way of a camera of the cleaning apparatus, relative to one or more reference points that are fixedly connected to the bumper; and
the control unit being configured to process the image data to determine the position information regarding the position of the bumper based on the image data.

2. The control unit according to claim 1, wherein:
the camera is arranged in a housing of the cleaning apparatus and the camera is concealed by the bumper;
the bumper is formed with an opening within a capture region of the camera and the camera is configured to capture image data relative to an environment of the cleaning apparatus through the opening of the bumper; and
the one or more reference points are arranged within the capture region of the camera.

3. The control unit according to claim 2, wherein:
the one or more reference points are arranged on a non-transparent edge of the opening of the bumper; and/or
the one or more reference points comprise the non-transparent edge of the opening of the bumper.

4. The control unit according to claim 2, wherein:
the opening of the bumper is covered by a window pane; and
the one or more reference points comprise one or more markings on the window pane.

5. The control unit according to claim 1, wherein:
the image data comprises at least one image in which the one or more reference points are represented; and
the control unit is configured:
to determine one or more properties of the one or more reference points represented in the image; and
to determine the position information on a basis of the one or more properties so determined.

6. The control unit according to claim 5, wherein the one or more properties of a respective reference point represented in the image are selected from the group consisting of:
a position of the reference point within the image;
a size of the reference point represented; and
a shape of the reference point represented.

7. The control unit according to claim 5, wherein:
the control unit is configured to determine the position information relative to the position of the bumper by using a predefined assignment function; and
the assignment function is configured to assign different positions of the bumper to different combinations of one or more properties of the one or more reference points.

8. The control unit according to claim 7, wherein the assignment function comprises at least one of a look-up table or one or more analytical functions.

9. The control unit according to claim 1, wherein the control unit is configured:
to capture reference image data, by way of the camera relative to the one or more reference points, when the bumper is in a given reference position; and
to calibrate, on the basis of the reference image data, an assignment function which is used to determine the position information relative to the position of the bumper on the basis of the image data.

10. The control unit according to claim 9, wherein the given reference position is a resting position of the bumper.

11. The control unit according to claim 9, wherein the control unit is configured to calibrate the assignment function repeatedly.

12. The control unit according to claim 11, wherein the control unit is configured to calibrate the assignment function after at least one of a reset or a restart of the cleaning apparatus or before a start of a cleaning process.

13. The control unit according to claim 11, wherein the control unit is configured to calibrate the assignment function before a start of each individual cleaning process.

14. The control unit according to claim 1, wherein the control unit is configured:
to determine whether or not a lighting situation is present; and
when the lighting situation is present, to bring about an illumination of the one or more reference points by one or more lighting elements of the cleaning apparatus.

15. The control unit according to claim 1, wherein:
the image data comprises an overview image in which the one or more reference points and an environment of the cleaning apparatus are represented; and
the control unit is configured:
to crop the overview image in order to provide a partial image in which the environment of the cleaning apparatus is represented but not the one or more reference points; and
to cause the partial image to be displayed to a user of the cleaning apparatus.

16. The control unit according to claim 1, wherein the control unit is configured to operate at least one of a cleaning unit or a drive unit of the cleaning apparatus as a function of the position information.

17. The control unit according to claim 1, wherein the position information comprises at least one of:
a position of the bumper relative to a housing of the cleaning apparatus;
an orientation of the bumper relative to a housing of the cleaning apparatus; or
a pose of the bumper relative to the housing of the cleaning apparatus.

18. A cleaning apparatus, comprising:
a cleaning unit configured to clean a surface on which the cleaning apparatus is disposed;
a bumper movably mounted on a housing of the cleaning apparatus;
a camera configured to capture image data relative to an environment of the cleaning apparatus; and
a control unit according to claim 1 configured to determine position information of a position of the bumper.

19. The cleaning apparatus according to claim 18 being a cleaning robot.

20. A method for determining position information referencing a position of a bumper that is movably mounted on a cleaning apparatus, the method comprising:
capturing image data, by way of a camera of the cleaning apparatus, relative to one or more reference points connected to the bumper; and
determining the position information regarding the position of the bumper on a basis of the image data.
